(19) United States
(12) Patent Application Publication
(10) Pub. No.: US 2019/0179547 A1
(43) Pub. Date: Jun. 13, 2019

(54) Performance Level Adjustments in Memory Devices

(71) Applicant: Micron Technology, Inc., Boise, ID (US)

(72) Inventor: Zoltan Szubbocsev, Haimhausen (DE)

(21) Appl. No.: 15/840,709

(22) Filed: Dec. 13, 2017

(51) Int. Cl. G06F 3/06; G06F 1/12; G06F 13/42; G06F 13/16

(52) U.S. Cl. CPC G06F 3/0625; G06F 3/0688; G06F 13/1694; G06F 1/12; G06F 13/4234; G06F 3/0659

(57) ABSTRACT

A memory device having a communication interface, a memory, and a controller configured to: receive a command in the communication interface to access the memory, determine a workload level of the controller in execution of the command; select a computation performance level of the controller according to the workload level; and set the controller at the computation performance level during the execution of the command.

### FIELD OF THE TECHNOLOGY

At least some embodiments disclosed herein relate to computer storage devices in general and more particularly, but not limited to power management in memory devices.

### BACKGROUND

A memory system may include multiple memory modules and a memory controller. Some techniques to manage power consumption in the memory system have been developed.

For example, U.S. Pat. No. 9,384,818, entitled “Memory Power Management” and published on Jul. 5, 2016, discloses a technique of setting a circuitry in a lower power mode when no read or write operation is performed on a particular memory module.

For example, U.S. Pat. No. 9,189,053, entitled “Performance based Power Management of a Memory and a Data Storage System using the Memory” and published on Nov. 17, 2015, discloses a technique of supplying a memory array with a voltage corresponding to a memory performance level, which may be a full performance level and a power-saving performance level.

For example, U.S. Pat. No. 8,745,427, entitled “Memory Link Power Management” and published on Jun. 3, 2014, discloses that various components of a memory subsystem may enter low power states under certain operating conditions, such as when a memory controller being empty of transactions directed towards a memory unit.

For example, U.S. Pat. No. 7,730,338, entitled “Interface Circuit System and Method for Autonomously Performing Power Management Operations in Conjunction with a Plurality of Memory Circuits” and published on Jun. 1, 2010, discloses an interface circuit that autonomously perform a first power management operation in a first command operation period on a first memory circuit and a second power management operation in a second command operation period on a second memory circuit, where the power management operations are initiated by non-power management signals, such as address signals and data signals.

The entire disclosures of the above discussed patents are hereby incorporated herein by reference.

### BRIEF DESCRIPTION OF THE DRAWINGS

The embodiments are illustrated by way of example and not limitation in the figures of the accompanying drawings in which like references indicate similar elements.

FIG. 1 illustrates a memory device according to one embodiment.

FIG. 2 illustrates a configuration file to adjust an operating parameter of a memory device according to one embodiment.

FIG. 3 illustrates a command that can be analyzed by a memory device to adjust one of its operating parameters according to one embodiment.

FIG. 4 shows a method to operate a memory device according to one embodiment.

FIG. 5 shows a detailed method to operate a memory device according to one embodiment.

### DETAILED DESCRIPTION

At least some embodiments disclosed herein provide a memory device that estimates the workload of a received command for a controller of the memory device and adjusts an operating parameter of the controller (e.g., clock speed) to manage power consumption and/or temperature of the memory device without, if any, significant degradation in the overall performance of the memory device.

A memory device is typically enclosed within a package without an internal cooling element. The power consumption management techniques disclosed herein can reduce power consumption and/or manage the temperature of the memory device, especially when the memory device is used under an extreme temperature, such as in a vehicle operated on a hot day.

The memory device may include a set of components, such as one or more memory chips and a controller chip, which are stacked and sealed in a same integrated circuit package. Depending on the commands received in a memory device, the performance bottleneck may or may not be in the controller.

During the execution of some commands with some datasets, the performance bottleneck of the memory device may be in the controller; and during the execution of other commands with other datasets, the performance bottleneck of the memory device may be in one or more of the memory chips. Thus, the performance balance among the components within the memory device may be dependent on the type of operations (e.g., read, write, erase) to be performed for the received command and/or the size and pattern of the dataset to be operated upon for the command.

When the performance bottleneck is not in the controller, the controller may be operated at a reduced performance level and thus at a reduced power consumption level, without degrading the overall performance of the memory device in completing the received command.

Preferably, in response to a given command the controller of the memory device is operated at a specific performance level that matches with the performance constraint of the other components of the memory device, such as a further increase in the performance level of the controller does not further reduce the execution time of the command as a whole.

For example, the performance level of the controller of the memory device may be throttled via the adjustment of the clock speed of the memory device. During the executing of a given command having a given set of data, the clock speed of the controller may be reduced to an optimal level without increasing the executing time of the command for the given data. Preferably, the clock speed reduction is optimized such that a further reduction in the clock speed from the optimal level causes the controller to be the performance bottleneck and increases the executing time. On the other hand, increasing the clock speed from the optimal level increases power consumption without reducing the executing time of the command. Thus, the increased clock speed is not optimal.

In general, a memory device has a set of components. Each of the components can have varying performance levels corresponding to different trade-off points in performance and power consumption. For a given command on a specific dataset, an optimal performance level set is determined for the components such that increasing a performance level of one of the components increases power consumption without reducing the executing time for the command on the dataset; and decreasing a performance level of one of the components from the optimal performance level set increases the executing time of the command. Preferable, the components are operated at the optimal performance level set for the given command with the dataset. Thus, the performance levels of the components can be set on a command by command basis.

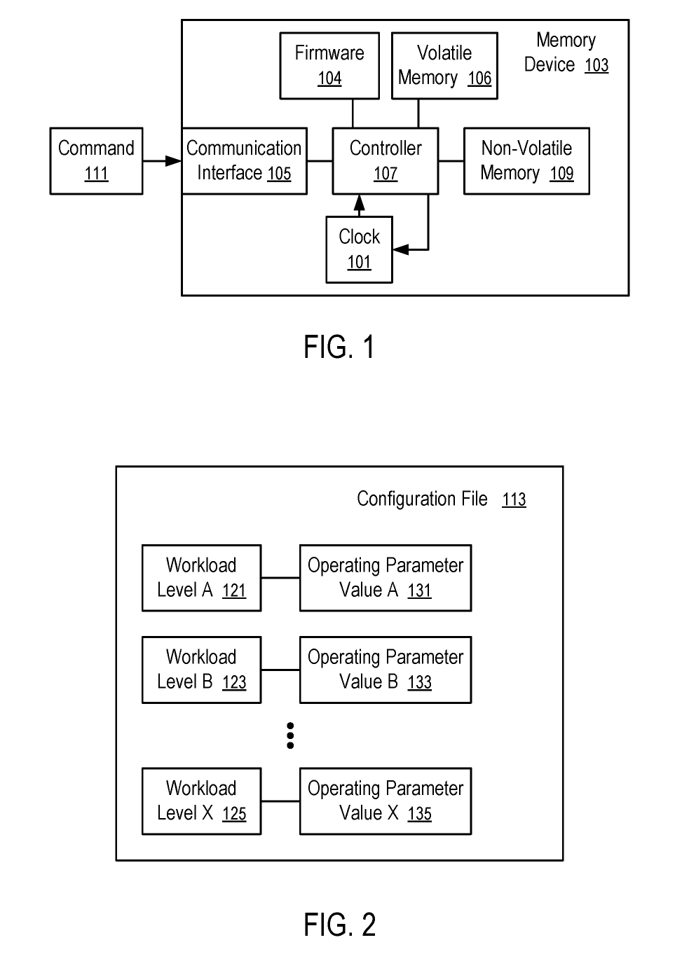

FIG. 1 illustrates a memory device (103) according to one embodiment.

The storage device (103) illustrated in FIG. 1 includes a controller (107), a communication interface (105), non-volatile memory (109), volatile memory (106), and optionally, firmware (104).

In FIG. 1, the performance of the controller (107) is controllable via a clock (101). When the frequency of the clock (101) (e.g., clock speed) is increased, the computation performance of the controller (107) increases to reduce the time period required to perform a given operation by the controller (107). However, increasing the clock speed increases power consumption by the controller (107).

In some instances, the controller (107) has different circuits for performing a same operation. The circuits have different trade-offs in performance and power consumption. For example, a first circuit is high in computation performance and high in power consumption; and a second circuit is low in computation performance and low in power consumption. Thus, the performance of the controller (107) can be controlled via the selection of a circuit from the different circuits for the operation during the execution of a particular command.

In some instances, the controller (107) has multiple parallel processors/circuits that may be used in parallel to increase computation performance. However, using an increasing number of parallel processors/circuits increases the peak power consumption and/or the total power consumption for the performance of a given task.

When the memory device (103) receives a command (111) via the communication interface (105), the controller (107) typically performs computations in connection with data access in the volatile memory (106) and/or in the non-volatile memory (109).

The overall computation performance of the memory device (103) for the execution of the command (111) can be measured as the time period for the completion of operations related to the command (111) in the memory device (103), including the operations performed by the controller (107) and the operations performed by the volatile memory (106) and/or the non-volatile memory (109).

The overall power performance of the memory device (103) for the execution of the command (111) can be measured as the total power consumption for the completion of operations related to the command (111) in the memory device (103), including the operations performed by the controller (107) and the operations performed by the volatile memory (106) and/or the non-volatile memory (109).

The overall thermal performance of the memory device (103) for the execution of the command (111) can be measured as the temperature variations caused by the completion of operations related to the command (111) in the memory device (103), including the operations performed by the controller (107) and the operations performed by the volatile memory (106) and/or the non-volatile memory (109).

During the execution of some commands that are intensive in computation, the overall time for the completion of a command (111) is limited by the computation performance of the controller (107). In such a situation, the controller (107) may be operated at a high performance mode (e.g., using a high clock speed, a high performance circuit, and/or multiple parallel processing circuits) to improve the overall computation performance of the memory device (103).

During the execution of some commands that are intensive in data access, the overall time for the completion of a command is limited by the data access performance of the memory (109 and/or 106). In such a situation, the controller (107) may be operated at a low performance mode (e.g., using a low clock speed, a low performance circuit, and/or less or no parallel processing circuits) to improve the overall power/thermal performance of the memory device (103).

In FIG. 1, the operations performed by the controller (107) are controlled by the firmware (104), which may be initially stored in a section of the non-volatile memory (109) and then loaded in the volatile memory (106) for execution. Alternatively, the function of the firmware (104) may be implemented using a hardware circuitry (e.g., using Application-Specific Integrated Circuit (ASIC) or Field-Programmable Gate Array (FPGA))

For example, the selection of a performance mode of the controller (107) for the execution of the command (111) can be implemented using the firmware (104) and/or a hardware circuit in the controller (107).

For example, an operating parameter value can be used to configure the controller (107) at a specific performance mode. For example, the operating parameter value may be a clock speed, the identification of a circuit to be selected from multiple circuits having the same function but different performance trade-offs, a degree of parallel processing, etc. The operating parameter value can be associated with a workload level in a configuration file for the determination of a performance mode of the controller (107) for the given command (111).

FIG. 2 illustrates a configuration file (113) to adjust an operating parameter of a memory device (103) according to one embodiment. For example, the configuration file (113) may be stored in the memory device (103) of FIG. 1 (e.g., as part of the firmware (104)) to configure the operation of the controller (107).

The configuration file (113) of FIG. 2 identifies a set of values (131, 133, . . . , 135) of an operating parameter of the controller (107) for a corresponding set of workload levels (121, 123, . . . , 125).

When the workload level of the controller (107) for the command (111) is estimated to be at a threshold level (e.g., 121, 123, . . . , or 125) in the configuration file (113), the corresponding value (e.g., 131, 133, . . . , 135) of the operating parameter can be looked up from the configuration file (113) to configure the performance mode of the controller (107) for the command (111).

Preferably, the workload levels (e.g., 121, 123, . . . , or 125) of the controller (107) are load estimates relative to, or normalized by, the performance of the memory (109 or 106). For example, the workload levels (e.g., 121, 123, . . . , or 125) may be the estimated amount of operations of the controller (107) normalized by the estimated amount of time for data access in the memory (109 or 106).

For example, when the workload level of the controller (107) is above the threshold level A (121), the operating parameter value (131) is used to operate the controller (107) at full capacity.

For example, when the workload level of the controller (107) is between the threshold level A (121) and the threshold level B (123), the operating parameter value (133) is used to operate the controller (107) at a reduced level of capacity to improve power/thermal performance without degradation in the overall performance of the memory device (103), as compared to operating at the full capacity at using the operating parameter value (131).

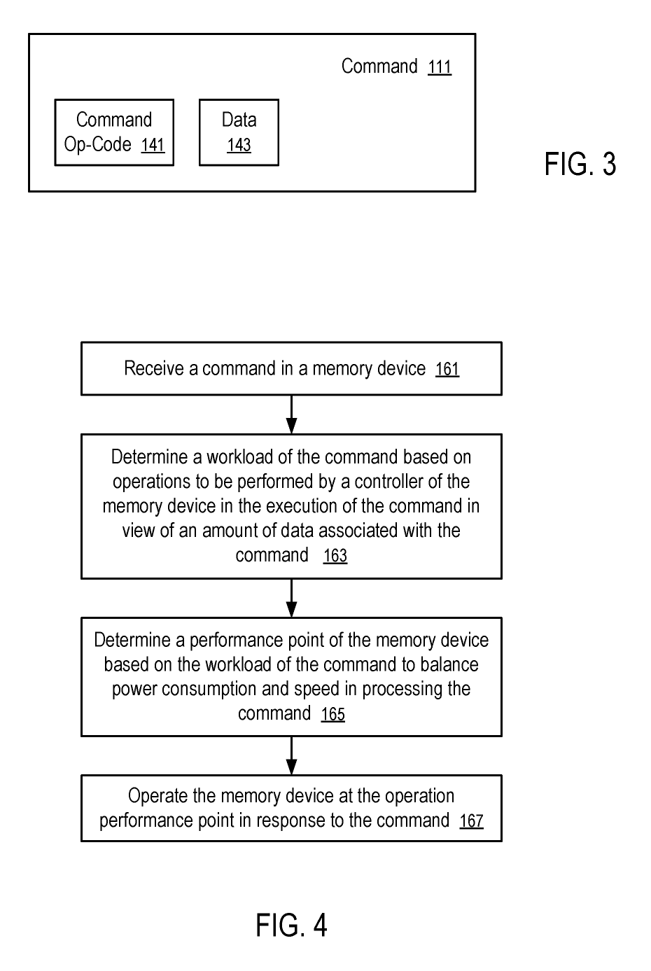

The command (111) received in the communication interface (105) typically specifies a type of operations and a dataset to be operated by, as illustrated in FIG. 3. The workload level of the controller can be estimated based on both the type of operations (e.g., read, write, erase) and the characteristics of the dataset, such as the size of the dataset, whether the dataset resides on a same memory chip, whether the dataset is on a continuous address block.

FIG. 3 illustrates a command (111) that can be analyzed by a memory device (103) of FIG. 1 to adjust one of its operating parameters (e.g., using the configuration file of FIG. 2).

The command (111) illustrated in FIG. 3 includes a command op-code (141) and data (143). The command op-code (141) specifies the type of operations, such as a read operation, a write operation. The data (143) specifies a dataset to be operated upon (e.g., via addresses). The time required for the memory (e.g., 109 and/or 106) to complete the command (111) typically depends on the type of operations, such as read, write, erase, etc.

The time required for the memory (e.g., 109 and/or 106) to complete the command (111) may also be dependent on characteristics of the data (143), such as the size of the dataset, whether the dataset is in a contiguous address block, whether the dataset is in the same or different memory chips that may be accessed in parallel, etc.

Similarly, the amount of operations to be performed by the controller (107) can be estimated based on the command op-code (141) and/or the characteristics of the dataset identified by the data (143) of the command (111).

From the estimated time requirement of the memory (e.g., 109 and/or 106) of the memory device (103) to complete the command (111) and the estimated amount of computation operations to be performed by the controller (107), a normalized workload level can be determined for comparison with the thresholds (e.g., 121, 123, . . . , 125) in the configuration file (113) to select an operating parameter value (e.g., 131, 133, . . . , or 135) that is used to configure the performance mode of the controller (107) during the execution of the command (111).

In some instances, the operation of the memory device (103) may be restricted by its thermal performance in the current operating environment. For example, the memory device (103) may include a temperature sensor. When the temperature of the memory device (103) is above a threshold, the memory device (103) may be operated at a reduced performance level to reduce heat generated by the memory device (103). For example, the controller (107) may extend the memory access over a longer period of time (e.g., by introducing idle cycles between data access cycles in using the memory (109/106), operating the memory (109) at a reduced clock speed); thus, the estimated time for the performance of the command (111) is increased; and the computational performance level of the controller (107) can be reduced accordingly to reduce power consumption and/or reduce peak power consumption for reduced impact on the temperature of the memory device (103).

In general, a host may communicate the command (111) to the memory device (103) via a communication channel using a predetermined protocol. The host may be a computer having one or more Central Processing Units (CPUs) to which computer peripheral devices, such as the memory device (103), may be attached via an interconnect, such as a computer bus (e.g., Peripheral Component Interconnect (PCI), PCI eXtended (PCI-X), PCI Express (PCIe)), a communication portion, and/or a computer network.

The memory device (103) can be used to store data for the host in the non-volatile memory (109). Examples of computer memory devices in general include hard disk drives (HDDs), solid state drives (SSDs), flash memory, dynamic random-access memory, magnetic tapes, network attached storage device, etc. The communication interface (105) of the memory device (103) implements communications with the host using a communication channel. For example, the communication channel between the host (101) and the storage device (103) can be a Peripheral Component Interconnect Express (PCI Express or PCIe) bus in one embodiment; and the host (101) and the storage device (103) communicate with each other using NVMe protocol (Non-Volatile Memory Host Controller Interface Specification (NVMHCI), also known as NVM Express (NVMe)).

In some implementations, the communication channel between the host and the memory device (103) includes a computer network, such as a local area network, a wireless local area network, a wireless personal area network, a cellular communications network, a broadband high-speed always-connected wireless communication connection (e.g., a current or future generation of mobile network link); and the host and the memory device (103) can be configured to communicate with each other using data storage management and usage commands similar to those in NVMe protocol.

The controller (107) of the memory device (103) runs firmware (104) to perform operations responsive to the commands (e.g., 111) from the host. Firmware in general is a type of computer program that provides control, monitoring and data manipulation of engineered computing devices. In FIG. 1, the firmware (104) controls the operations of the controller (107) in operating the memory device (103), such as the estimation of the workload level of the controller (107) for the given command (111), the selection of an operating parameter value (e.g., 131, 133, . . . , 135), and the configuring the performance mode of the controller (107) according to the selected operating parameter value (e.g., 131, 133, . . . , 135).

The memory device (103) typically has non-volatile memory (109), such as magnetic material coated on rigid disks, and/or memory cells in an integrated circuit. The memory (109) is non-volatile in that no power is required to maintain the data/information stored in the non-volatile memory (109), which data/information can be retrieved after the non-volatile memory (109) is powered off and then powered on again. The memory cells may be implemented using various memory/storage technologies, such as NAND gate based flash memory, phase-change memory (PCM), magnetic memory (MRAM), resistive random-access memory, and 3D XPoint, such that the storage media (109) is non-volatile and can retain data stored therein without power for days, months, and/or years.

The memory device (103) may include volatile memory (106) (e.g., Dynamic Random-Access Memory (DRAM)) for the storage of run-time data and instructions used by the controller (107) to improve the computation performance of the controller (107) and/or provide buffers for data transferred between the host (101) and the non-volatile memory (109). The memory (106) is volatile in that it requires power to maintain the data/information stored therein, which data/information is lost immediately or rapidly when the power is interrupted.

Volatile memory (106) typically has less latency than non-volatile memory (109), but loses its data quickly when power is removed. Thus, it is advantageous to use the volatile memory (106) to temporarily store instructions and data used for the controller (107) in its current computing task to improve performance. In some instances, the volatile DRAM is replaced with volatile Static Random-Access Memory (SRAM) that uses less power than DRAM in some applications. When the non-volatile memory (109) has data access performance (e.g., in latency, read/write speed) comparable to volatile memory (106), the volatile memory (106) can be eliminated; and the controller (107) can perform computing by operating on the non-volatile memory (109) for instructions and data instead of operating on the volatile memory (106).

For example, cross point storage and memory devices (e.g., 3D XPoint memory) have data access performance comparable to volatile memory (106). A cross point memory device uses transistor-less memory elements, each of which has a memory cell and a selector that are stacked together as a column. Memory element columns are connected via two perpendicular lays of wires, where one lay is above the memory element columns and the other lay below the memory element columns. Each memory element can be individually selected at a cross point of one wire on each of the two layers. Cross point memory devices are fast and non-volatile and can be used as a unified memory pool for processing and storage.

In some instances, the controller (107) has in-processor cache memory with data access performance that is better than the volatile memory (106) and/or the non-volatile memory (109). Thus, it is preferred to cache parts of instructions and data used in the current computing task in the in-processor cache memory of the controller (107) during the computing operations of the controller (107). In some instances, the controller (107) has multiple processors, each having its own in-processor cache memory. In some instances, the volatile memory (106) is implemented in the chip for the controller (107) (e.g., as the cache memory).

Optionally, the controller (107) performs data intensive, in-memory processing using data and/or instructions organized in the memory device (103). For example, in response to a request from the host (101), the controller (107) performs a real time analysis of a set of data stored in the memory device (103) and communicates a reduced data set to the host (101) as a response. For example, in some applications, the memory device (103) is connected to real time sensors to store sensor inputs; and the processors of the controller (107) are configured to perform machine learning and/or pattern recognition based on the sensor inputs to support an artificial intelligence (AI) system that is implemented at least in part via the memory device (103) and/or the host (101).

In some implementations, the processors of the controller (107) are integrated with memory (e.g., 106 or 109) in computer chip fabrication to enable processing in memory and thus overcome the von Neumann bottleneck that limits computing performance as a result of a limit in throughput caused by latency in data moves between a processor and memory configured separately according to the von Neumann architecture. The integration of processing and memory increases processing speed and memory transfer rate, and decreases latency and power usage.

The memory device (103) can be used in various computing systems, such as a cloud computing system, an edge computing system, a fog computing system, and/or a standalone computer. In a cloud computing system, remote computer servers are connected in a network to store, manage, and process data. An edge computing system optimizes cloud computing by performing data processing at the edge of the computer network that is close to the data source and thus reduces data communications with a centralize server and/or data storage. A fog computing system uses one or more end-user devices or near-user edge devices to store data and thus reduces or eliminates the need to store the data in a centralized data warehouse.

At least some embodiments of the inventions disclosed herein can be implemented using computer instructions executed by the controller (107), such as the firmware (104). In some instances, hardware circuits can be used to implement at least some of the functions of the firmware (104). The firmware (104) can be initially stored in the non-volatile memory (109), or another non-volatile device, and loaded into the volatile memory (106) and/or the in-processor cache memory for execution by the controller (107).

For example, the firmware (104) can be configured to implement the techniques herein for the performance level adjustments of the memory device (103). However, the techniques discussed herein are not limited to being used in the memory device (103) of FIG. 1. For example, the memory device may be a solid state drive, a removable memory card, an embedded Universal Flash Storage memory chip, with more or less components than the memory device (103) illustrated in FIG. 1.

FIG. 4 shows a method to operate a memory device according to one embodiment. For example, the method of FIG. 4 can be implemented in the memory device (103) of FIG. 1 using a configuration file (113) of FIG. 2 in response to a command (111) illustrated in FIG. 3.

The method of FIG. 4 includes: receiving (161) a command (111) in a memory device (103); determining (163) a workload of the command (111) based on operations to be performed by a controller (107) of the memory device (103) in the execution of the command (111) in view of an amount of data (143) associated with the command (111); determining (165) a performance point (e.g., represented by an operating parameter value (131, 133, . . . , or 135)) of the memory device (103) based on the workload of the command (111) to balance power consumption and speed in processing the command (111); and operating (167) the memory device (103) at the operation performance point (e.g., using the operating parameter value (131, 133, . . . , or 135)) in response to the command (111).

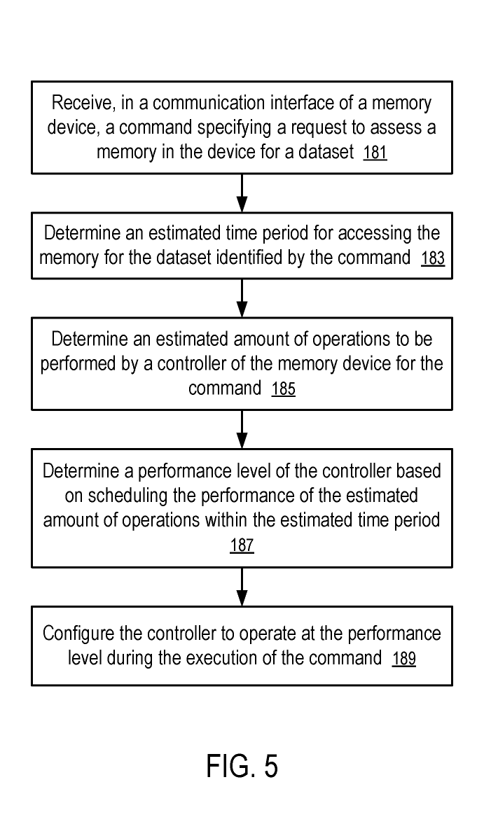

FIG. 5 shows a detailed method to operate a memory device according to one embodiment. For example, the method of FIG. 4 can be implemented in the memory device (103) of FIG. 1 using a configuration file (113) of FIG. 2 in response to a command (111) illustrated in FIG. 3.

The method of FIG. 5 includes: receiving, (181) in a communication interface (105) of a memory device (103), a command (111) specifying a request to assess a memory (e.g., 109 or 106) in the device (103) for a dataset (e.g., identified at least in part via addresses of the dataset in the memory); determining (183) an estimated time period for accessing the memory for the dataset identified by the command (111); determining (185) an estimated amount of operations to be performed by a controller (107) of the memory device (103) for the command (111); determining (187) a performance level (e.g., represented by an operating parameter value (131, 133, . . . , or 135)) of the controller (107) based on scheduling the performance of the estimated amount of operations within the estimated time period; and configuring (189) the controller (107) to operate at the performance level during the execution of the command (111) (e.g., according to an operating parameter value (131, 133, . . . , or 135)).

For example, the method includes the determination of a workload level of the controller (107) in execution of the command (111) based on the estimated time period used to access the non-volatile memory (109) of the memory device (103) during the execution of the command (111) and the estimated amount of computations performed by the controller (107) during the execution of the command (111).

For example, the workload level of the controller (107) may be normalized with respect to the estimated time period used to access the non-volatile memory (109) of the memory device (103) during the execution of the command (111) such that the workload level is proportional to the estimated amount of computations performed by the controller (107) during the execution of the command (111) and inversely proportional to the estimated time.

For example, the computation performance level can be reduced, based on the normalized workload level, from a maximum performance level of the controller (107).

Preferably, the time period for execution of the command at the reduced computation performance level is substantially the same as the time period for execution of the command at the maximum performance level, such that reducing the performance level of the controller (107) does not adversely affect the performance of the memory device (103) as a whole.

Preferably, the computation performance level is reduced to an optimized point such that the time period for execution of the command at the optimized computation performance level is shorter than the time period for execution of the command at any performance level lower than the computation performance level optimized for the command.

When the command is executed at the reduced computation performance level of the controller, the total and/or peak power consumption of the memory device is lower than executing the command at the maximum performance level.

The computation performance level of the controller (107) may be adjusted via the clock speed of the controller (107), a level of parallel processing, the selection of one of several circuits that have the same function but different trade-offs between computational performance and power/thermal performances, etc.

For example, the controller (107) may be operated at a maximum clock speed, which can be reduced to a reduced clock speed for operating at the reduced computation performance level with an improved power/thermal performance.

For example, the reduced clock speed may be selected based on the normalized workload level according to a configuration file (113) illustrated in FIG. 2.

In some implementations, the controller (107) is formed on a silicon chip that is separate from the silicon chip(s) for the non-volatile memory (109). The silicon chips of the memory device (103) are sealed within the same integrated circuit package of the memory device (103). The controller (107) and the non-volatile memory (109) may operate under different clock signals.

In some implementations, a temperature sensor is provided in the memory device (103) to determine a temperature of the memory device at a time of the command. The temperature measurement represents a thermal constraint and can be used to determine the estimated time used to access the non-volatile memory during the execution of the command without overheating the memory device (103) above a threshold.

Preferably, the workload level is determined, as a function of the estimated lengths of the time period for accessing the non-volatile memory (109) for a dataset identified by the command (111) and an estimated amount of computations to be performed by the controller (107) during the execution of the command (111), based at least in part on one of: locations of a dataset to be stored in or retrieved from the non-volatile memory (109); whether or not the dataset is on a continuous block of addresses; whether or not the dataset is in a same memory chip; and/or a size of the dataset.

A non-transitory computer storage medium can be used to store instructions of the firmware (104). When the instructions are executed by the controller (107) of the computer memory device (103), the instructions cause the controller (107) to perform any of the methods discussed above.

In this description, various functions and operations may be described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor or microcontroller, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects.

A tangible, non-transitory computer storage medium can be used to store software and data which, when executed by a data processing system, causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in their entirety prior to the execution of the applications. Alternatively, portions of the data and instructions can be obtained dynamically, just in time, when needed for execution. Thus, it is not required that the data and instructions be on a machine-readable medium in their entirety at a particular instance of time.

Examples of computer-readable storage media include, but are not limited to, recordable and non-recordable type media such as volatile and non-volatile memory devices, read only memory (ROM), random access memory (RAM), flash memory devices, floppy and other removable disks, magnetic disk storage media, and optical storage media (e.g., Compact Disk Read-Only Memory (CD ROM), Digital Versatile Disks (DVDs), etc.), among others. The instructions may be embodied in a transitory medium, such as electrical, optical, acoustical or other forms of propagated signals, such as carrier waves, infrared signals, digital signals, etc. A transitory medium is typically used to transmit instructions, but not viewed as capable of storing the instructions.

In various embodiments, hardwired circuitry may be used in combination with software instructions to implement the techniques. Thus, the techniques are neither limited to any specific combination of hardware circuitry and software, nor to any particular source for the instructions executed by the data processing system.

Although some of the drawings illustrate a number of operations in a particular order, operations that are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

The above description and drawings are illustrative and are not to be construed as limiting. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A memory device, comprising:
a non-volatile memory;
a communication interface to receive a command to access the non-volatile memory of the memory device; and
a controller configured to:
determine a workload level of the controller in execution of the command;
select a computation performance level of the controller according to the workload level; and
set the controller at the computation performance level during the execution of the command.

2. The memory device of claim 1, wherein the computation performance level includes a clock speed according to which the controller executes operations.

3. The memory device of claim 2, wherein the controller is in a first silicon chip; and
the non-volatile memory is in one or more second silicon chips.

4. The memory device of claim 3, wherein the first silicon chip and the one or more second silicon chips are configured within a same integrated circuit package of the memory device.

5. The memory device of claim 3, wherein the controller and the non-volatile memory operate under different clock signals.

6. The memory device of claim 1, wherein the workload level is normalized with respect to an estimated time used to access the non-volatile memory during the execution of the command.

7. The memory device of claim 6, wherein the workload level is proportional to an estimated amount of computations performed by the controller during the execution of the command and inversely proportional to the estimated time used to access the non-volatile memory during the execution of the command.

8. The memory device of claim 7, wherein the computation performance level is reduced from a maximum performance level of the controller.

9. The memory device of claim 8, wherein a time period for execution of the command at the computation performance level is substantially same as a time period for execution of the command at the maximum performance level.

10. The memory device of claim 9, wherein a time period for execution of the command at the computation performance level is shorter than a time period for execution of the command at a performance level lower than the computation performance level.

11. The memory device of claim 9, wherein the memory device consumes less power for the execution of the command at the computation performance level of the controller than at the maximum performance level.

12. The memory device of claim 9, wherein the memory device consumes less peak power during the execution of the command at the computation performance level of the controller than at the maximum performance level.

13. The memory device of claim 12, wherein the computation performance level corresponds to running the controller at a first clock speed; and the maximum performance level corresponds to running the controller a second clock speed higher than the first clock speed.

14. The memory device of claim 8, further comprising:
a temperature sensor to determine a temperature of the memory device at a time of the command;
wherein the estimated time used to access the non-volatile memory during the execution of the command is estimated based on the temperature.

15. The memory device of claim 1, wherein the memory device is one of:
a solid state drive;
a removable memory card; and
an embedded universal flash storage memory chip.

16. A method implemented in a memory device, the method comprising:
receiving a command to access a non-volatile memory of the memory device; and
in response to the command:
determining a workload level of a controller in execution of the command;
selecting a computation performance level of the controller according to the workload level; and
setting the controller at the computation performance level during the execution of the command.

17. The method of claim 16, wherein the workload level is determined based on:
an estimated time used to access the non-volatile memory during the execution of the command; and
an estimated amount of computations performed by the controller during the execution of the command.

18. The method of claim 17, wherein the workload level is determined based on a type of the command and data of the command.

19. The method of claim 18, wherein the workload level is based at least in part on one of:
locations of a dataset to be stored in or retrieved from the non-volatile memory;
a size of the dataset; and
whether or not the dataset is on a continuous block of addresses.

20. A non-transitory computer storage medium storing instructions which, when executed on a memory device, cause the memory device to perform a method, the method comprising:
receiving a command to access a non-volatile memory of the memory device; and
in response to the command:
determining a workload level of a controller in execution of the command;
selecting a computation performance level of the controller according to the workload level; and
setting the controller at the computation performance level during the execution of the command.
